(19) United States
(12) Patent Application Publication
(10) Pub. No.: US 2022/0410385 A1
(43) Pub. Date: Dec. 29, 2022

(54) Program Creation Apparatus, And Storage Medium

(71) Applicant: SEIKO EPSON CORPORATION, Tokyo (JP)

(72) Inventor: Yuma SHIMURA, Matsumoto (JP)

(21) Appl. No.: 17/848,461

(22) Filed: Jun. 24, 2022

(30) Foreign Application Priority Data
Jun. 25, 2021 (JP) 2021-105468

(51) Int. Cl. B25J 9/16

(52) U.S. Cl. CPC B25J 9/1633; B25J 9/1664

(57) ABSTRACT

A program creation apparatus acquires a work sequence executed by a robot, and creates a robot motion program containing a motion program based on the work sequence, an execution mode that can be enabled or disabled, and a command to switch to enable or disable the execution mode.

The present application is based on, and claims priority from JP Application Serial Number 2021-105468, filed Jun. 25, 2021, the disclosure of which is hereby incorporated by reference herein in its entirety.

### BACKGROUND

### 1. Technical Field

The present disclosure relates to a program creation apparatus, a program, and a robot motion program.

### 2. Related Art

For example, as disclosed in JP-A-2017-64844, in related art, program automatic creation apparatuses creating motion programs for robot to execute work on objects are known. In the program automatic creation apparatus disclosed in JP-A-2017-64844, steps of work are created as a flowchart and a motion program is automatically generated based on the created flowchart.

Work of a robot often includes various motions and, after an entire program is automatically generated, a user sometimes corrects the program with respect to each motion. When the program for a predetermined motion is corrected, it is necessary to reflect the correction on another motion relating to the motion. However, the entire program is automatically generated by the program automatic creation apparatus, and it is difficult for the user to understand the entire program and to reflect the correction on the other motion.

### SUMMARY

A program creation apparatus according to an aspect of the present disclosure acquires a work sequence executed by a robot, and creates a robot motion program containing a motion program based on the work sequence, an execution mode that can be enabled or disabled is switchable, and a command to switch to enable or disable the execution mode.

A non-transitory computer-readable storage medium storing a program according to an aspect of the present disclosure acquires a work sequence executed by a robot, and creates a robot motion program containing a motion program based on the work sequence, an execution mode that can be enabled or disabled, and a command to switch to enable or disable the execution mode.

A non-transitory computer-readable storage medium storing a robot motion program according to an aspect of the present disclosure includes a motion program based on a work sequence executed by a robot, an execution mode that can be enabled or disabled, and a command to switch to enable or disable the execution mode.

### BRIEF DESCRIPTION OF THE DRAWINGS

FIG. 1 is a perspective view showing an overall configuration of a robot system according to a preferred embodiment.

FIG. 2 is a block diagram showing a program creation apparatus.

FIG. 3 shows an example of a window displayed by the program creation apparatus.

FIG. 4 shows an example of a window displayed by the program creation apparatus.

FIG. 5 is a block diagram showing a problem in related art.

FIG. 6 shows part of a program.

FIG. 7 shows part of the program.

FIG. 8 shows part of the program.

FIG. 9 shows part of the program.

### DESCRIPTION OF EXEMPLARY EMBODIMENTS

As below, a program creation apparatus, a program, and a robot motion program according to the present disclosure will be explained in detail based on preferred embodiments shown in the accompanying drawings.

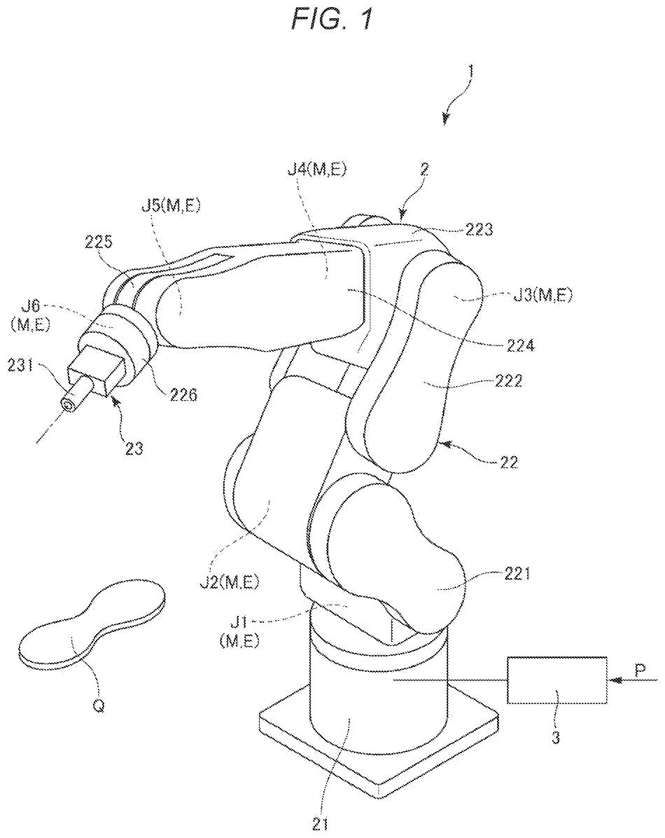

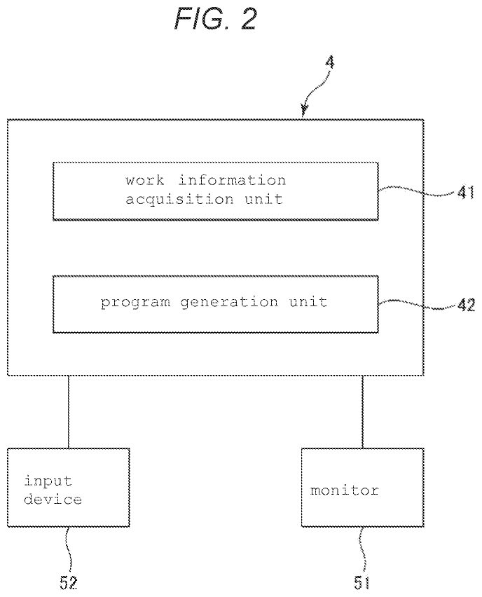

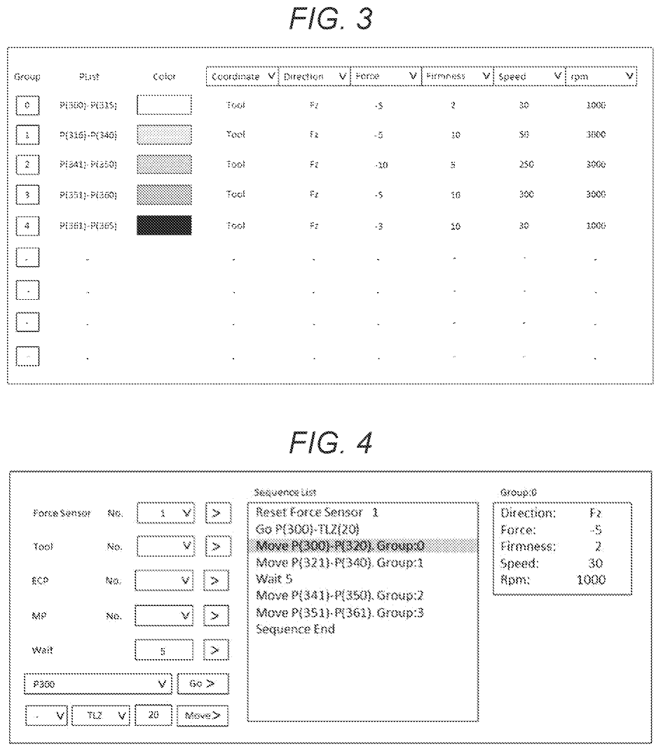

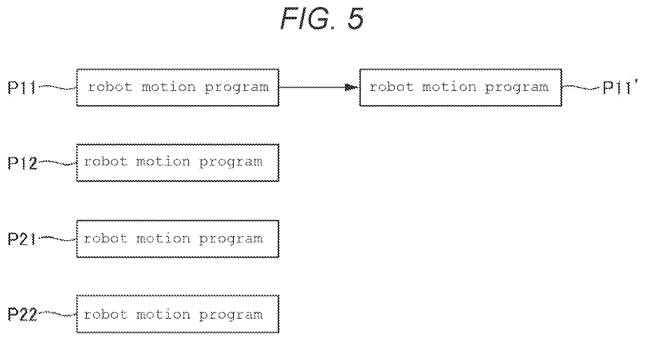

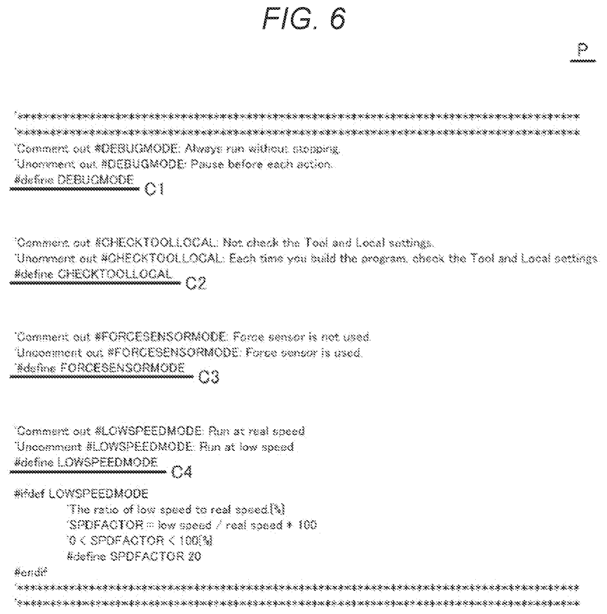

FIG. 1 is a perspective view showing an overall configuration of a robot system according to a preferred embodiment. FIG. 2 is a block diagram showing a program creation apparatus. FIGS. 3 and 4 respectively show examples of windows displayed by the program creation apparatus. FIG. 5 is a block diagram showing a problem in related art. FIGS. 6 to 9 show part of a program.

Prior to the explanation of a program creation apparatus 4 automatically creating a robot motion program P, a robot system 1 driven based on the robot motion program P automatically created by the program creation apparatus 4 will be briefly explained. As shown in FIG. 1, the robot system 1 has a robot 2 and a robot control apparatus 3 controlling driving of the robot 2 based on the robot motion program P.

The robot 2 is a six-axis robot having six drive axes. The robot 2 has a base 21 and a robot arm 22 pivotably coupled to the base 21, and an end effector 23 is attached to the distal end portion of the robot arm 22.

The robot arm 22 is a robotic arm in which a plurality of arms 221, 222, 223, 224, 225, 226 are pivotably coupled and includes six joints J1 to J6. Of the joints, the joints J2, J3, J5 are bending joints and the joints J1, J4, J6 are twisting joints. Further, motors M and encoders E are respectively provided in the joints J1, J2, J3, J4, J5, J6.

The end effector 23 is coupled to the arm 226. The end effector 23 is detachable from the arm 226 and one suitable for work executed by the robot 2 may be selected and attached. The end effector 23 of the embodiment has an abrasive wheel 231 driven to rotate, and the robot 2 executes polishing work to smooth the surface of an object Q.

As above, the robot 2 is explained, however, the configuration of the robot 2 is not particularly limited. For example, the robot 2 may be a scalar robot (horizontal articulated robot), a dual-arm robot, or the like. Further, the robot 2 may be fixed to a floor or the like to be immovable or fixed to a mobile apparatus such as an automated guided vehicle (AGV) to be movable.

The robot control apparatus 3 controls driving of the robot system 1 based on the robot motion program P automatically created by the program creation apparatus 4.

The robot control apparatus 3 consists of e.g. a computer and includes a processor processing information, a memory communicably connected to the processor, and an external interface for coupling to an external apparatus. Various programs that can be executed by the processor are stored in the memory, and the processor may read and execute the various programs stored in the memory.

As above, the robot system 1 is briefly explained. Next, the program creation apparatus 4 creating the robot motion program P will be explained.

The program creation apparatus 4 consists of e.g. a computer and includes a processor processing information, a memory communicably connected to the processor, and an external interface for coupling to an external apparatus. Various programs PP that can be executed by the processor are stored in the memory, and the processor may read and execute the programs PP. The programs PP are software automatically creating the robot motion program P and hardware with the software installed therein is the program creation apparatus 4.

As shown in FIG. 2, the program creation apparatus has a work information acquisition unit 41 acquiring information on work executed by the robot 2, and a program generation unit 42 generating the robot motion program P based on the information on the work acquired by the work information acquisition unit 41. Further, a monitor 51 as a display device and an input device 52 such as a keyboard or a mouse is coupled to the program creation apparatus 4.

As a first step, for example, the work information acquisition unit 41 displays an input window (graphic user interface) shown in FIG. 3 on the screen of the monitor 51 and receives a motion executed by the robot 2 via the input device 52 from the user.

The received motion is not particularly limited. In the example shown in FIG. 3, the user may assign one motion to one “Group” and may input and designate “PList” showing a start point and an end point of a movement of the end effector 23, “Coordinate” showing a coordinate used in “PList”, “Direction” showing a pressing direction of the end effector 23 on the object Q, “Force” showing a pressing force of the end effector 23 on the object Q, “Firmness” showing firmness of the object Q, “Speed” showing a movement speed of the end effector 23, and “rpm” showing a rotation speed of the abrasive wheel 231. In the example shown in FIG. 3, five of Group 0, Group 1, Group 2, Group 3, Group 4 are created by the user.

After receiving the motion from the user, the work information acquisition unit 41 displays an input window (graphic user interface) as shown in FIG. 4 on the screen of the monitor 51 and creates a work sequence according to an instruction from the user via the input device 52. In this regard, the order of execution of Group 0, Group 1, Group 2, Group 3, Group 4 set at the first step may be determined, and another motion may intervene between the successive Groups.

The work sequence shown in FIG. 4 is to execute in the order of Group 0, Group 1, Group 2, Group 3, and further, initialize a force sensor (not shown) provided in the robot arm 22 before execution of Group 0, move the end effector 23 from P(300) as a start position of Group 0 to a location slightly apart, and, after the end of Group 1, wait for five seconds and start Group 2.

The program generation unit 42 creates the robot motion program P based on the work sequence created according to an instruction from the user at a second step. The created robot motion program P contains a motion program P0 based on the work sequence executed by the robot 2, execution modes that can be enabled or disabled, and commands to switch to enable or disable the execution modes. Note that the execution modes are not particularly limited, but include e.g. a force control mode, a low-speed execution mode, a sequential execution mode, a low torque mode, and a coordinate system check mode. These are the modes frequently used in drive control of the robot 2, and the highly convenient robot motion program P may be obtained.

Of the modes, the force control mode is a mode of feeding back output from the force sensor of the robot arm 22 to driving of the robot 2. The low-speed execution mode is a mode of slowly driving the robot arm 22 at a predetermined speed or less at e.g. test driving. The sequential execution mode is a mode in which the robot 2 stops at each time when finishing one motion and starts the next motion by an instruction from the user at e.g. test driving. The low torque mode is a mode of driving the robot arm 22 with low torque equal to or less than predetermined torque for increasing safety for e.g. a human-coexistence robot. The coordinate system check mode is a mode of checking whether or not e.g. a coordinate system used for control of the robot 2 (a local coordinate system set for the object Q or a tool coordinate system set for the end effector 23) is right with the user.

Note that, as below, for convenience of explanation, a case where the robot motion program P contains the force control mode, the low-speed execution mode, the sequential execution mode, and the coordinate system check mode as the execution modes will be representatively explained.

According to the robot motion program P having the above described configuration, the plurality of execution modes may be managed by the single robot motion program P, and thereby, when a parameter relating to a certain execution mode is corrected, consideration of synchronization with another execution mode is not necessary. In other words, when a parameter relating to a certain execution mode is corrected, the correction is reflected on another execution mode.

Specifically, in a case where different programs are created with respect to each execution mode e.g. a robot motion program P11 in which the force control mode is enabled, a robot motion program P12 in which the force control mode is disabled, a robot motion program P21 in which the low-speed execution mode is enabled, a robot motion program P22 in which the low-speed execution mode is disabled as shown in FIG. 5, for example, when a parameter in the robot motion program P11 is corrected and a robot motion program P11′ is formed, the correction is not automatically reflected on the other robot motion programs P12, P21, P22.

Therefore, the user should make the same correction for the corresponding parts of the other robot motion programs P12, P21, P22 for synchronization. However, not all users necessarily have the sufficient knowledge about the programs. Users having insufficient knowledge do not know the portions of the robot motion programs P12, P21, P22 to correct for synchronization, and the correction is very difficult and mistakes in confirmation are easily caused.

On the other hand, according to the robot motion program P of the embodiment, as described above, the single program contains the plurality of execution modes, and, when a parameter in the robot motion program P is corrected, the other execution modes are automatically synchronized. Therefore, even the users having insufficient knowledge may easily correct the robot motion program P.

FIG. 6 shows part of the robot motion program P. As shown in FIG. 6, in the robot motion program P, as the commands, a command C1 to select to enable/disable the sequential execution mode, a command C2 to select to enable/disable the coordinate system check mode, a command C3 to select to enable/disable the force control mode, a command C4 to select to enable/disable the low-speed execution mode are described in lines. For example, when “′” are input at the heads, i.e., before “#” of the respective commands C1, C2, C3, C4, the respective commands C1, C2, C3, C4 are commented out and disabled, and, when “′” are deleted before “#”, the respective commands C1, C2, C3, C4 are enabled.

Accordingly, in the state shown in FIG. 6, the sequential execution mode=enabled, the coordinate system check mode=enabled, the force control mode=disabled, and the low-speed execution mode=enabled. In this manner, in the robot motion program P, enabled/disabled of the respective execution modes may be selected with or without “′”, and thereby, even the users having insufficient knowledge about the program may easily switch to enable/disable the execution modes.

Particularly, in the embodiment, all commands C1, C2, C3, C4 are collectively displayed in a part, and the user may easily check the statuses of the respective execution modes and select to enable/disable the modes. Accordingly, the robot motion program P easy to handle may be obtained. Note that “collectively displayed in a part” also refer to e.g. a state without irrelevant description to the commands between the commands C1, C2, C3, C4.

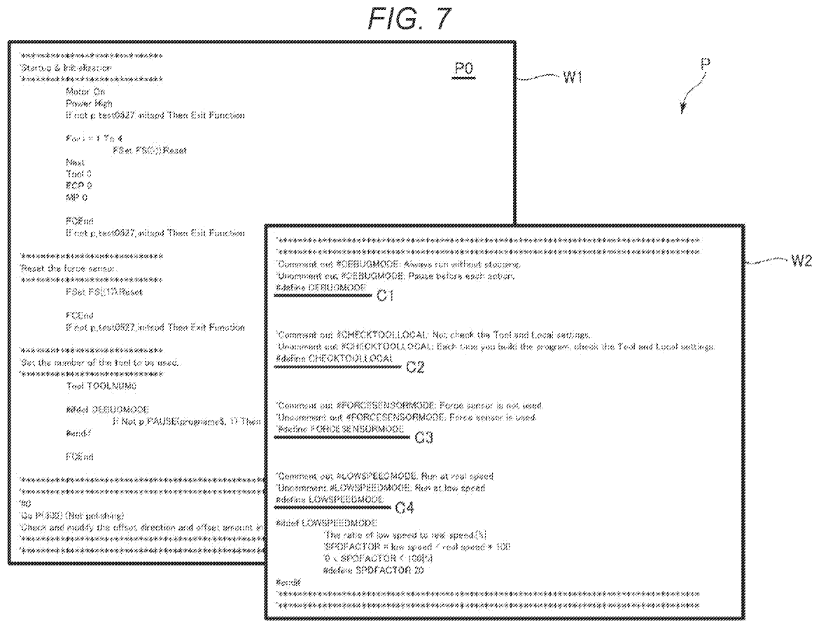

Furthermore, in the embodiment, as shown in FIG. 7, the commands C1, C2, C3, C4 may be displayed in another window W2 than a window W1 displaying the motion program P0 contained in the robot motion program P. Substantially, only the commands C1, C2, C3, C4 are displayed in the window W2, and thereby, the effort to search for the commands C1, C2, C3, C4 in the robot motion program P is saved. Therefore, the robot motion program P easy to handle may be obtained.

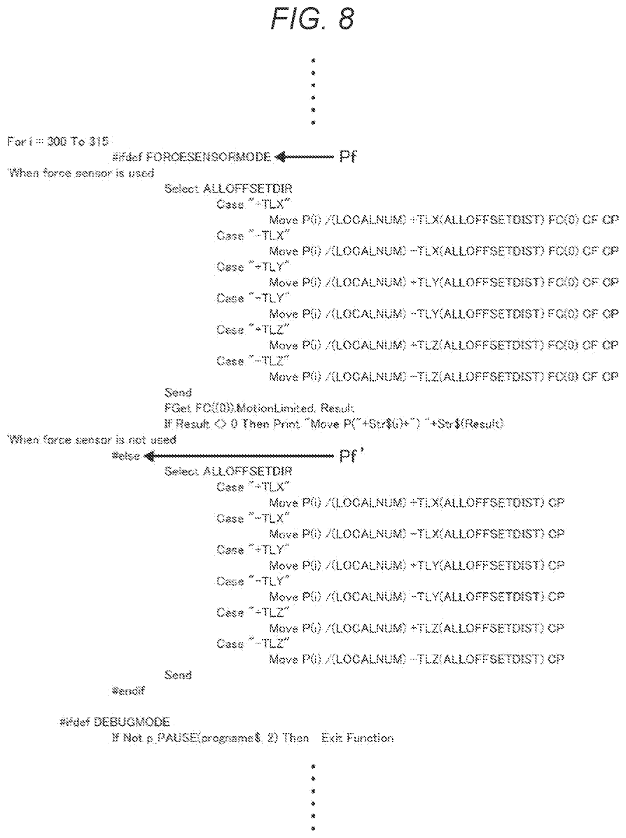

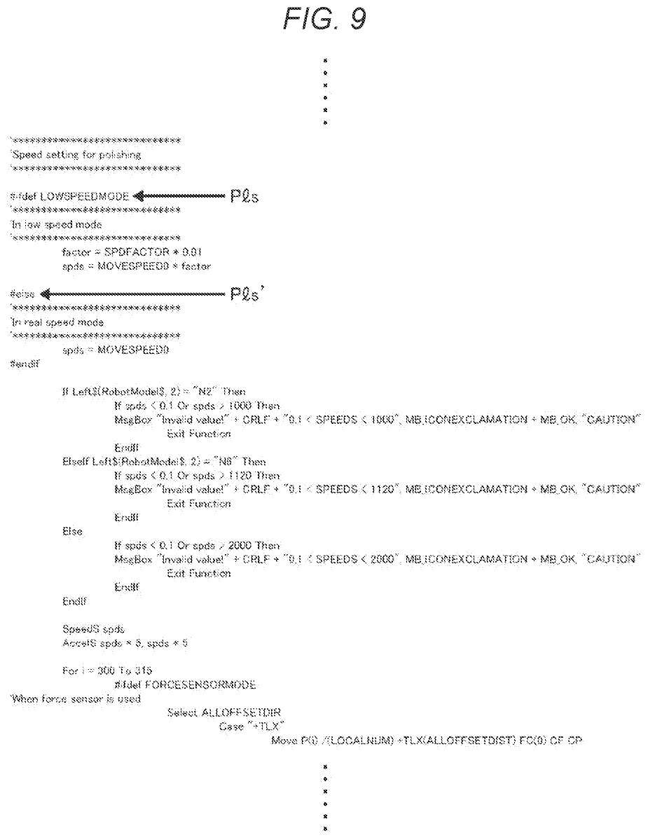

Here, part of the force control mode contained in the motion program P0 is shown in FIG. 8. As shown in FIG. 8, in the motion program, a program Pf for a case where the force control mode is enabled and a program Pf′ for a case where the force control mode is disabled are described together and, when the force control mode is enabled in the command C3, the program Pf is selected and, when the force control mode is disabled, the program Pf′ is selected. Similarly, part of the low-speed execution mode contained in the motion program is shown in FIG. 9. As shown in FIG. 9, in the motion program, a program Pls for a case where the low-speed execution mode is enabled and a program Pls′ for a case where the low-speed execution mode is disabled are described together and, when the low-speed execution mode is enabled in the command C4, the program Pls is selected and, when the low-speed execution mode is disabled, the program Pls′ is selected.

As above, the program creation apparatus 4, the programs PP, and the robot motion program P are explained. As described above, the program creation apparatus 4 acquires the work sequence executed by the robot 2, and creates the robot motion program P containing the motion program P0 based on the work sequence, the execution modes that can be enable or disable, and the commands C1, C2, C3, C4 to switch to enable or disable the execution modes. According to the configuration, the single robot motion program P contains the programs when the execution modes are enabled and the programs when the execution modes are disabled, and, when a parameter in the robot motion program P is corrected, the other execution modes are automatically synchronized. Therefore, even the users having insufficient knowledge may easily correct the robot motion program P.

Further, as described above, as the execution modes, the program contains at least one of the force control mode of controlling driving of the robot 2 based on a received force, the low-speed execution mode of driving the robot 2 at a predetermined speed or less, the sequential execution mode in which the robot 2 stops at each time when finishing one motion, the low torque mode of driving the robot 2 with predetermined torque or less, and the coordinate system check mode of inquiring whether or not the coordinate system used for control of the robot 2 is right. Thereby, the highly convenient robot motion program P may be obtained.

As described above, the robot motion program P has the plurality of execution modes and the plurality of commands C1, C2, C3, C4 corresponding to the respective execution modes are collectively described in the robot motion program P. Thereby, the user may easily check the statuses of the respective execution modes and select to enable/disable the modes. Accordingly, the robot motion program P easy to handle may be obtained.

Further, as described above, the commands C1, C2, C3, C4 are displayed in the other window W2 than that for the motion program P0 based on the work sequence on the screen of the monitor 51 as the display device. Thereby, the effort to search for the commands C1, C2, C3, C4 in the robot motion program P is saved. Therefore, the robot motion program P easy to handle may be obtained.

Furthermore, as described above, the program PP acquires the work sequence executed by the robot 2, and creates the robot motion program P containing the motion program P0 based on the work sequence, the execution modes that can be enabled or disabled, and the commands C1, C2, C3, C4 to switch to enable or disable the execution modes. According to the configuration, the single robot motion program P contains the programs when the execution modes are enabled and the programs when the execution modes are disabled, and, when a parameter in the robot motion program P is corrected, the other execution modes are automatically synchronized. Therefore, even the users having insufficient knowledge may easily correct the robot motion program P.

As described above, the robot motion program P contains the motion program P0 based on the work sequence executed by the robot 2, the execution modes that can be enabled or disabled, and the commands C1, C2, C3, C4 to switch to enable or disable the execution modes. According to the configuration, the single robot motion program P contains the programs when the execution modes are enabled and the programs when the execution modes are disabled, and, when a parameter in the robot motion program P is corrected, the other execution modes are automatically synchronized. Therefore, even the users having insufficient knowledge may easily correct the robot motion program P.

As above, the program creation apparatus, the program, and the robot motion program according to the present disclosure are explained based on the illustrated embodiments, however, the present disclosure is not limited to those. The configurations of the respective parts may be replaced by arbitrary configurations having the same functions. Further, any other configuration may be added to the present disclosure. Furthermore, the respective embodiments may be appropriately combined.

What is claimed is:

1. A program creation apparatus acquiring a work sequence executed by a robot, and
creating a robot motion program containing a motion program based on the work sequence, an execution mode that can be enabled or disabled, and a command to switch to enable or disable the execution mode.

2. The program creation apparatus according to claim 1, wherein
the robot motion program contains, as the execution mode, at least one of a force control mode of controlling driving of the robot based on a received force, a low-speed execution mode of driving the robot at a predetermined speed or less, a sequential execution mode in which the robot stops at each time when finishing one motion, a low torque mode of driving the robot with predetermined torque or less, and a coordinate system check mode of inquiring whether or not a coordinate system used for control of the robot is right.

3. The program creation apparatus according to claim 1, wherein
the robot motion program has a plurality of the execution modes, and
a plurality of the commands corresponding to the respective execution modes are collectively described in the robot motion program.

4. The program creation apparatus according to claim 1, wherein
the command is displayed in another window than that for the motion program based on the work sequence on a screen of a display device.

5. A non-transitory computer-readable storage medium storing a program that
acquires a work sequence executed by a robot, and
creates a robot motion program containing a motion program based on the work sequence, an execution mode that can be enabled or disabled, and a command to switch to enable or disable the execution mode.

6. A non-transitory computer-readable storage medium storing a robot motion program comprising:
a motion program based on a work sequence executed by a robot;
an execution mode that can be enabled or disabled; and
a command to switch to enable or disable the execution mode.
